(19) United States
(12) Patent Application Publication
(10) Pub. No.: US 2022/0358913 A1
(43) Pub. Date: Nov. 10, 2022

(54) METHOD FOR FACILITATING SPEECH ACTIVITY DETECTION FOR STREAMING SPEECH RECOGNITION

(71) Applicant: Gnani Innovations Private Limited, Bengaluru (IN)

(72) Inventor: Prajwal RAO, Bengaluru (IN)

(21) Appl. No.: 17/570,725

(22) Filed: Jan. 7, 2022

(30) Foreign Application Priority Data
May 5, 2021 (IN) 202141020535

(51) Int. Cl. G10L 15/197; G06F 40/279; G10L 25/78; G10L 15/22; G10L 15/06; G06N 20/00

(52) U.S. Cl. CPC G10L 15/197; G06F 40/279; G10L 25/78; G10L 15/22; G10L 15/063; G06N 20/00

(57) ABSTRACT

The present disclosure relates to a system and method for automatic recording of speech. The system is configured for end of sentence detection which may also perform as a punctuation predictor. The system uses interrelated Natural Language Processing (NLP) and Automatic Speech Recognition (ASR) with a switching mechanism. The switching mechanism decides when the ASR should start or stop recording for processing. The decision is made by using a temporal neural network which tells the switching mechanism whether a meaningful sentence is formed or not. The temporal neural network is a sequence to classification network which is trained on a huge dataset for news articles.

### TECHNICAL FIELD

The present disclosure relates to a system and a method for speech recognition. More importantly, the present disclosure relates to a system and a method for an automated Voice activity detection with punctuation prediction.

### BACKGROUND

Background description includes information that may be useful in understanding the present invention. It is not an admission that any of the information provided herein is prior art or relevant to the presently claimed invention, or that any publication specifically or implicitly referenced is prior art.

In recent years, end-to-end Neural Network based Automatic Speech Recognition (ASR) systems have become increasingly popular, outperforming the Hidden Markov Models (HMM) and Gaussian Mixture Models (GMM) that were previously state-of-the-art. Inserting punctuation automatically has drawn decent attention prior to the emergence of end-to-end ASR systems. Many of the systems predicted punctuation using combined prosodic features and n-gram language models. The most widely used prosodic features are pause and pitch and they have shown to be relatively effective.

However, the use of such prosodic features still imposes an information bottleneck where only the pause and pitch around the potential location for inserting punctuation are considered. More subtle information, such as the overall pace of the sentence, pitch variation of the entire sequence would sometimes be discarded. There seems to be less interest in automatic punctuation in ASR systems since the emergence of end-to-end Neural Network systems due to lack of a large amount of corpus with punctuated transcripts. Moreover in a conversational situation, such as chatbots, an immersive solution for query and reply situations without delay is required. Existing solutions use VAD (voice activity detection) for stopping the ASR inference when the person stops speaking. This causes an issue of delay as it has to wait till a specific amount of silence is reached. Also, once the speech to text is stopped, the text has to be processed using natural language processing techniques to generate a meaningful reply. The reply then has to be converted into a corresponding speech. The whole process takes time and is not feasible in situations where there is a lot of background noise, word viruses (Such as ‘um’, ‘ahh’) and repeating phrases (‘I I I’, ‘we can do this, you know, we can . . . ’).

Therefore, there is a need in the art to provide a system and a method that can record an audio signal pertaining to speech without any delay caused by VAD, ASR, NLP and other pre-processing/postprocessing overheads.

### OBJECTS OF THE PRESENT DISCLOSURE

Some of the objects of the present disclosure, which at least one embodiment herein satisfies are as listed herein below.

It is an object of the present disclosure to provide a system and a method that enables voice activity detection (VAD) assisted speech recognition. It is an object of the present disclosure to provide a system and a method to facilitate customization to address any specific language or a combination of languages.

It is an object of the present disclosure to provide a system and a method that facilitates to provide a fast and immersive solution for query and reply situations without delay.

It is an object of the present disclosure to provide a system and a method that facilitates inclusion of background noise, gender voice variations, tones, word usage and variations.

It is an object of the present disclosure to provide a system and a method that predicts punctuations.

It is an object of the present disclosure to provide a system and a method for enabling and disabling speech streaming/recording.

### SUMMARY

This section is provided to introduce certain objects and aspects of the present invention in a simplified form that are further described below in the detailed description. This summary is not intended to identify the key features or the scope of the claimed subject matter.

In order to achieve the aforementioned objectives, the present invention provides a system and method for enabling automatic speech recording. In an aspect, the system may include a processor that executes a set of executable instructions stored in a memory, upon execution of which, the processor causes the system to: receive a set of data packets from an audio device, the set of data packets corresponding to an audio signal which may be recorded by a speech recognition engine, convert, by the speech recognition engine, the audio signal into textual form; extract, by a classification engine, a first set of attributes from the textual form, the first set of attributes pertaining to any or a combination of a set of predefined words and punctuations, predict, by the classification engine, a second set of attributes from the first set of attributes, the second set of attributes pertaining to the predefined set of words and punctuations at any or a combination of beginning of the sentence, within the sentence and at the end of the sentence and may include, based on the predicted second set of attributes, facilitate by an ML engine, deactivation or activation of the recording of the audio signal.

In an embodiment, the audio signal may pertain to a conversation between at least a first user and a computing device.

In an embodiment, the ML engine may be configured to detect, predict and discard word viruses.

In an embodiment, on reaching the end of sentence, the execution of the speech recognition engine may be ended or deactivated by a switching mechanism, which may be configured to return the control again to the speech recognition engine that may include a voice activity detector.

In an embodiment, the ML engine may be configured by a plurality of training data comprising a set of predefined set of words and punctuations. The ML engine may learn and self-train from the plurality of training data to facilitate auto activation and deactivation of the recording of the audio signal.

The present invention provides a system and method for enabling automatic speech recording or streaming. The method may include the step of receiving a set of data packets from an audio device, the set of data packets corresponding an audio signal, the audio signal pertaining to a conversation between at least one user and a computing device. The audio signal may be recorded by a speech recognition engine. The method may further include the step of converting, by the speech recognition engine, the audio signal into textual form and the step of extracting, by a classification engine, a first set of attributes from the textual form, the first set of attributes pertaining to any or a combination of a set of predefined class of words and punctuations. Furthermore, the method may include the step of predicting, by the classification engine, a second set of attributes from the first set of attributes, the second set of attributes pertaining to the predefined set of words and punctuations at beginning of the sentence, within the sentence and/or at the end of the sentence and based on the predicted second set of attributes, by an ML engine, the method may further include facilitating deactivation or activation of the recording or streaming of the audio signal.

In an embodiment, the audio signal may pertain to a conversation between at least one user and a computing device.

In an embodiment, the ML engine may be configured to detect, predict and discard word viruses.

In an embodiment, on reaching the end of sentence, the execution of the speech recognition engine may be ended or deactivated by a switching mechanism. The switching mechanism may be configured to return the control again to the speech recognition engine that may include a voice activity detector.

In an embodiment, the ML engine may be configured by a a plurality of training data comprising a set of predefined set of words and punctuations. The ML engine may learn and self-train from the plurality of training data to facilitate auto activation and deactivation of the recording of the audio signal.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates exemplary network architecture in which or with which proposed system can be implemented in accordance with an embodiment of the present disclosure.

FIG. 2 illustrates an exemplary architecture of a processor in which or with which proposed system can be implemented in accordance with an embodiment of the present disclosure.

FIG. 3 illustrates an exemplary representation of a flow diagram for automatic recording of audio signal in accordance with an embodiment of the present disclosure.

FIG. 4 illustrates a generic representation of flow diagram of the proposed method in accordance with an embodiment of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

The present disclosure relates to a system and a method for speech recognition. More importantly, the present disclosure relates to a system and a method for voice activity detection with punctuation prediction.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, solid state drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. Thus, the present invention is to be accorded the widest scope encompassing numerous alternatives, modifications and equivalents consistent with the principles and features disclosed.

The present invention provides solution to the above-mentioned problem in the art by providing a system and a method for automatic activation and deactivation of recording or streaming of speech. Particularly, the system and method provide a solution where an audio signal pertaining to a speech of user may be automatically streamed or recorded and stopped when the user stops his speech. The audio signal may be converted to textual form by a speech recognition engine. A classification engine may extract a first set of attributes pertaining to certain predefined set of words and punctuations in the textual form. The classification engine may further predict a second set of attributes corresponding to the predefined set of words and punctuations at beginning of the sentence, within the sentence and/or at the end of the sentence and based on the predicted second set of attributes, an ML engine, may deactivate or activate the recording of the audio signal.

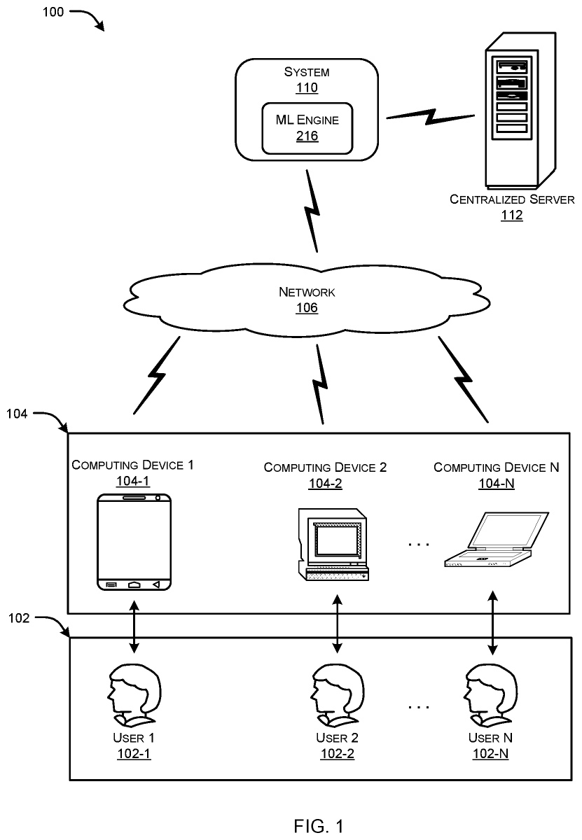

Referring to FIG. 1 that illustrates an exemplary network architecture (100) in which or with which system (110) of the present disclosure can be implemented, in accordance with an embodiment of the present disclosure. As illustrated, the exemplary architecture (100) includes a system (110) equipped with a Machine Learning (ML) engine (216) for automatic recording of speech. The audio signal pertaining to speech can be received from a plurality of users (102-1, 102-2, . . . 102-n) (hereinafter interchangeably referred as user 102 and collectively referred to as users 102). Each user may be associated with at least one computing device (104-1, 104-2, . . . 104-n) (hereinafter interchangeably referred as a smart computing device or audio device; and collectively referred to as 104). The users (102) may interact with the system (110) by using their respective computing device (104). The computing device (104) and the system (110) may communicate with each other over a network (106). The system (110) may be associated with a centralized server (112). Examples of the computing devices (104) can include, but are not limited to a smart phone, a portable computer, a personal digital assistant, a handheld phone and the like.

Further, the network 106 can be a wireless network, a wired network, a cloud or a combination thereof that can be implemented as one of the different types of networks, such as Intranet, BLUETOOTH, MQTT Broker cloud, Local Area Network (LAN), Wide Area Network (WAN), Internet, and the like. Further, the network 106 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like. In an exemplary embodiment, the network 104 can be an HC-05 Bluetooth module which is an easy to use Bluetooth SPP (Serial Port Protocol) module, designed for transparent wireless serial connection setup.

According to various embodiments of the present disclosure, the system 100 can provide for an Artificial Intelligence (AI) based automatic speech detection and speech input generation by using signal processing analytics, particularly for providing input services in at least one or more languages and dialects. In an illustrative embodiment, the speech processing AI techniques can include, but not limited to, a Language Processing Algorithm and can be any or a combination of machine learning (referred to as ML hereinafter), deep learning (referred to as DL hereinafter), and natural language processing using concepts of temporal neural network techniques. The technique and other data or speech model involved in the use of the technique can be accessed from a database in the server. The trained model may have 1D Convolutional Neural Network (CNN) feature extractors, bidirectional Long Short-Term Memory (LSTM) layers, and Connectionist Temporal Classification (CTC). In addition, a new set of CTC Tokens, suitable for predicting punctuations directly from a speech signal may also be included. An improved calculation for Slot Error Rate (SER) for calculation of SER of punctuations when the hypothesis transcript is not exactly aligning with the reference may be used along with the trained model.

In an aspect, the system (110) can receive a set of data packets pertaining to an audio signal (also referred to as speech input) from the computing device (104) which may be an audio device (104) but not limited to it. In an embodiment, the system (110) can receive an audio signal pertaining to speech corresponding to a conversation between at least one user among the plurality of users 102 and the computing device (104). The set of data packets received corresponding to the audio signal which may be recorded or streamed by the system (110). The system (110) may convert the audio signal into textual form to extract a first set of attributes pertaining to any or a combination of a set of predefined class of words and punctuations. The system (110) can then predict a second set of attributes from the first set of attributes, the second set of attributes pertaining to the set of predefined class of words and punctuations at beginning of the sentence, within the sentence and/or at the end of the sentence. Based on the predicted second set of attributes, facilitate by a Machine Learning (ML) engine (216) coupled to the system 110 to enable a switching mechanism for deactivation or activation of the recording or streaming of the audio signal to the speech recognition engine.

In an embodiment, the ML engine (216) may determine any or a combination of end of a sentence, start of the sentence and middle of the sentence or may determine a class of words belonging to a start word, stop word, middle word but not limited to the like based on the predicted second set of attributes to facilitate activation or deactivation of the recording or the streaming.

In another embodiment, the system (110) can determine a first dataset that can include a corpus of sentences of one or more predefined languages based on one or more predefined language usage parameters. In another embodiment, the language usage parameters can pertain to a corpus of sentences to define probabilities of different words occurring together to form a distribution of words to generate a sentence. In yet another embodiment, the distribution of data can be smoothed in order to improve performance for words in the first data set having lower frequency of occurrence. In an exemplary embodiment, news data can be scraped online but not limited to it may be used because it has meaningful text with proper punctuations that contain recordings of multiple sentences from various domains . . . . Each recording in the curated Corpus may be structured in: word position in sentence in class/category. Knowing the domain for each sentence, the data may be created with ease.

In an exemplary embodiment, the system (110) may be configured to detect, predict and discard word viruses such as ‘um’, ‘ahh’ and repeating phrases ‘I I I’, ‘we can do this, you know, we can . . . ’ and not limited to the like.

In an exemplary embodiment, the system (110) can be configured to filter out background noise.

In another embodiment, the system 10 can compare and map the speech input with related text. Speech processing techniques can be performed by applying neural network, lexicon, syntactic and semantic analysis and forwarding the analysis to structured speech input signal for providing required response to the speech input. In an aspect, a centralised server (112) can be operatively coupled with the system (110) that can store various speech models from which required response text can be selected.

In an embodiment, the system may provide features such as recording and saving of audio data with correct endpoints.

In an embodiment, the system (110) for automatic conversion of speech input to textual form may include a processor coupled with a memory, wherein the memory may store instructions which when executed by processor may cause the system to perform the extraction, prediction and generation of steps as described hereinabove.

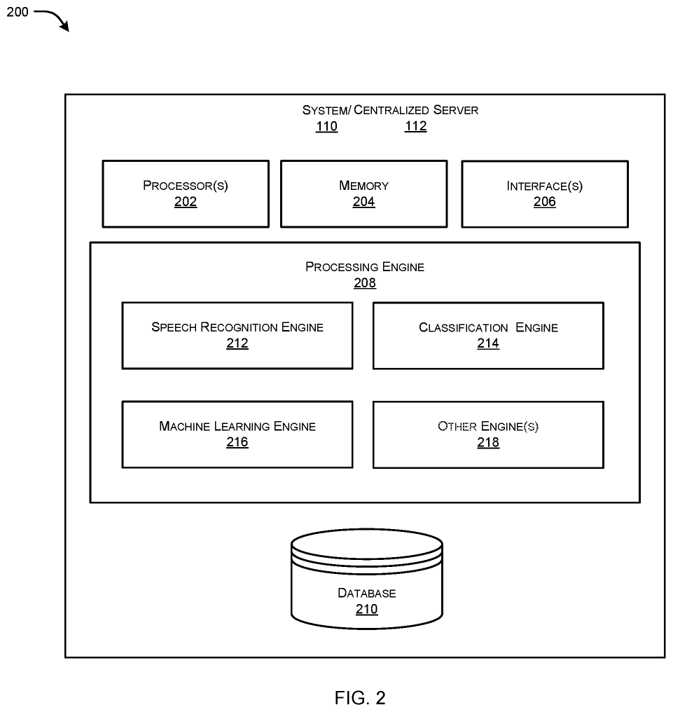

FIG. 2 illustrates an exemplary representation (200) of system (110) or a centralized server (112), in accordance with an embodiment of the present disclosure.

In an aspect, the system (110)/centralized server (112) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (102). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110)/centralized server (112) may include an interface(s) (206). The interface(s) (206) may comprise a variety of interfaces, for example, interfaces for data input and output devices, referred to as I/O devices, storage devices, and the like. The interface(s) 206 may facilitate communication of the system (110). The interface(s) (206) may also provide a communication pathway for one or more components of the centralized server (112). Examples of such components include, but are not limited to, processing engine(s) (208) and a database (210).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110)/centralized server (112) may comprise the machine-readable storage medium storing the instructions and the processing resource to execute the instructions, or the machine-readable storage medium may be separate but accessible to the system (110)/centralized server (112) and the processing resource. In other examples, the processing engine(s) (208) may be implemented by electronic circuitry.

The processing engine (208) may include one or more engines selected from any of a speech recognition engine (212), a classification engine (214), an ML engine (216) and other engines (218).

In an embodiment, the speech recognition engine (212) (also referred to as automatic speech recognition (ASR) engine (212) hereinafter) can receive a set of data packets pertaining to an audio signal from a computing device (104). In an embodiment, the audio signal may correspond to a speech input pertaining to a conversation between a first user (102-1) and a computing device (104). The speech recognition engine (212) may include a voice activity detector to detect activities in the speech signal.

In an embodiment, upon receiving the set of data packets, the ASR engine (212) can convert the audio signal to a textual form through speech processing techniques. Fourier Transform (FT), full Mel-frequency Cepstral Coefficients (MFCC) but not limited to the like may be used for pre-processing of the audio signal. In an exemplary embodiment, Short Time Fourier Transform (STFT) on the audio signal with a window of at least 20 ms and stride of at least 10 ms but not limited to it may be applied.

In an embodiment, the classification engine (214) may extract, a first set of attributes from the textual form. The first set of attributes may pertain to any or a combination of a set of predefined words and punctuations. The first set of attributes may be extracted using any/or a combination of textual classifier such as Transformer Networks but not limited to the like.

In another embodiment, the classification engine (214) may predict a second set of attributes from the first set of attributes. The second set of attributes may pertain to the predefined set of words and punctuations at any or a combination of beginning of the sentence, within the sentence and at the end of the sentence and based on the predicted second set of attributes, facilitate, by an ML engine (216) deactivation or activation of the recording or streaming of the audio signal to the speech recognition engine.

In another embodiment, on reaching the end of sentence, the ML engine (216) may enforce execution of the speech recognition engine (212) to end or deactivate by a switching mechanism. In yet another embodiment, the switching mechanism may be configured to return the control again to the speech recognition engine (212).

In an embodiment, the ML engine (216) can be configured by a plurality of training data comprising a set of predefined class of words and punctuations. In an exemplary implementation, artificial intelligence can be implemented using techniques such as Machine Learning (referred to as ML hereinafter) that can focus on the development of programs and can access data and use the data to learn from it. The ML can provide the ability for the system (110) to learn automatically and train the system (110) from experience without the necessity of being explicitly programmed. In another exemplary implementation, machine learning can be implemented using deep learning (referred to as DL hereinafter) which is a subset of ML and can be used for big data processing for knowledge application, knowledge discovery, and knowledge-based prediction. The DL can be a network capable of learning from unstructured or unsupervised data. In yet another exemplary implementation, artificial intelligence can use techniques such as Natural Language Processing (referred to as NLP hereinafter) which can enable the system (110) to understand human speech. The NLP can make extensive use of phases of compiler such as syntax analysis and lexical analysis. For example, NLP=Text Processing+Machine Learning. The NLP can make use of any or a combination of a set of symbols and a set of rules that govern a particular language. Symbols can be combined and used for broadcasting the response and rules can dominate the symbols in the language. The ML engine (216) can herein teach machines through its ability to perform complex tasks in language not limited to dialogue generation, machine translation, summarization of text, sentiment analysis. The present disclosure provides for a speech enabled input system to help in reducing human effort. This can be an added advantage.

Furthermore, the ML engine (216) may use a bidirectional Long Short Term Memory (BiLSTM) layers stacked together but not limited to the like for determination and prediction of a set of predefined punctuations. In an embodiment, the system (110) may use many state-of-the-art features including 2D CNN feature extractor, multilayer BiLSTM, CTC, LSTM-LM and the like. In another embodiment, the ML engine (216) may provide for CTC tokens that are suitable for generating punctuation marks directly from the audio signal. In yet another embodiment, a slot error rate for punctuations may be used by the ML engine (216) to determine punctuations with potentially misaligned text through Damerau-Levenshtein Distance.

Furthermore, in an exemplary embodiment, the system (110) may be configured to detect, predict and discard word viruses such as ‘um’, ‘ahh’ and repeating phrases ‘I I I’, ‘we can do this, you know, we can . . . ’ and not limited to the like.

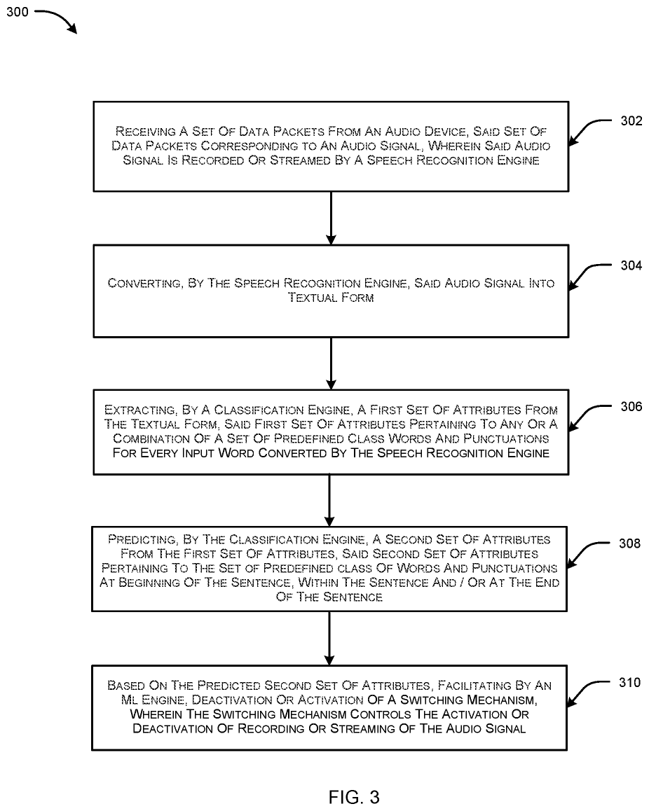

FIG. 3 illustrates an exemplary method flow diagram (300) depicting a method for in accordance with an embodiment of the present disclosure.

At step 302, the method includes the step of receiving a set of data packets from an audio device (104). The set of data packets corresponding an audio signal may be received by a speech recognition engine (212).

Further, at step 304, the method includes the step of converting, by the speech recognition engine (212), said audio signal into textual form. At step 306, the method includes the step of extracting, by a classification engine (214), a first set of attributes from the textual form, the first set of attributes pertaining to any or a combination of a set of predefined class of words and punctuations.

Furthermore, at step 308, the method includes the step of predicting, by the classification engine (214), a second set of attributes from the first set of attributes, the second set of attributes pertaining to the set of predefined class of words and punctuations for every input word at any or a combination of beginning of the sentence, within the sentence and at the end of the sentence or for every input word belonging to a class of words pertaining to a start word, a middle word or an end word but not limited to the like and based on the predicted second set of attributes, at step 310, the method includes the step of facilitating by an ML engine (216) deactivation and activation of the audio signal switching mechanism that may control the activation and deactivation of the recording or streaming of the audio signal to the speech recognition engine (212)

The system and method of the present disclosure may be further described in view of exemplary embodiments.

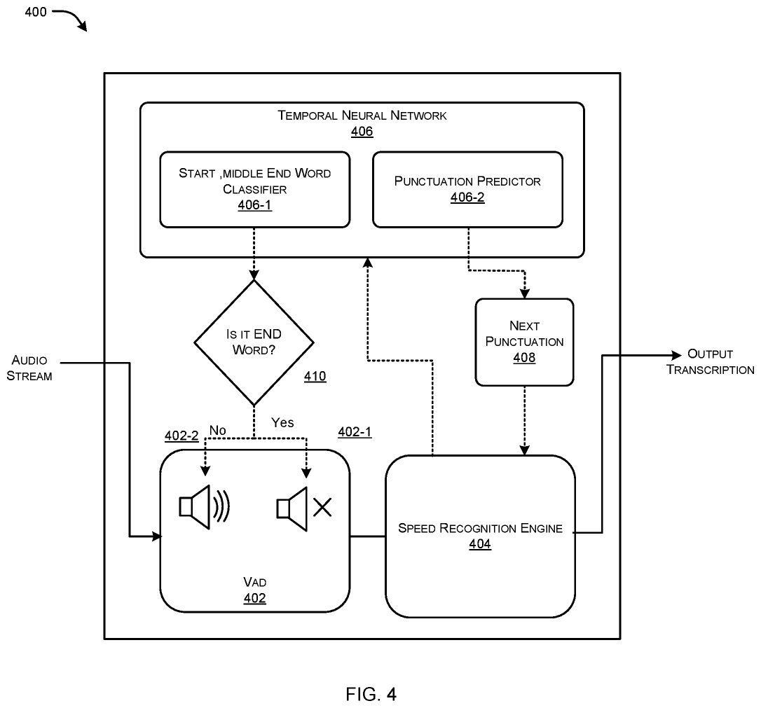

FIG. 4 illustrates an exemplary block diagram representation (400) of the proposed system, in accordance with an embodiment of the present disclosure.

As illustrated in FIG. 4, the block diagram includes a voice activity detection (VAD) 402 (also referred to as speech activity detection (SAD) or speech detection). The VAD (402) may be configured to detect presence or absence of human speech, used in speech processing. The main uses of the VAD may be in speech coding and speech recognition. VAD is an important enabling technology for a variety of speech-based applications. Therefore, various VAD algorithms have been developed that provide varying features and compromises between latency, sensitivity, accuracy and computational cost. Some VAD algorithms also provide further analysis, for example whether the speech is voiced, unvoiced or sustained. Voice activity detection is usually independent of language. The audio stream or the speech signal may be then provided to an automatic speech recognition (ASR) block at 404. The audio stream may be then converted to a textual form by the ASR (404). This textual form may be then fed into a temporal neural network (406) which may predict whether the word is a start-word, middle word, or an end word (406-1) and also the expected punctuation/no punctuation after the word by a punctuation predictor (406-2). The temporal neural network (406) through the punctuation predictor (406-2) also may predict the next punctuation at block 408.

The output of from the temporal neural network may be then fed into an ASR switching mechanism (ASM) which determines whether the end of a sentence has reached (410). If end of sentence is reached, then a switch at 402-1 may send a signal to the ASR to stop recording or streaming and predicting. Else if end of sentence is not reached, then the switch 402-2 may send a signal to the ASR to continue recording or streaming and predicting.

Thus, in an exemplary embodiment, the information which can be received from the subsystems can be monitored and displayed on the display device. The parameterized values can be stored within the proposed system for the offline data analysis in the future. It can be designed to addresses the modularity, scalability, reusability and maintainability features of the data monitoring unit. The proposed framework can also come up with a display device for visualization of logged data and can support Data archival process.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

Some of the advantages of the present disclosure, which at least one embodiment herein satisfies are as listed herein below.

The present disclosure provides for a system and method that enables voice activity detection coupled with punctuation prediction.

The present disclosure provides for a system and a method that enables voice activity detection (VAD) assisted speech recognition.

The present disclosure provides for a system and method to facilitate customization to address any specific language or a combination of languages.

The present disclosure provides for a system and method that facilitates to provide an immersive solution for query and reply situations without delay.

The present disclosure provides for a system and method that facilitates inclusion of background noise, gender voice variations, tones, word usage and variations.

The present disclosure provides for a system and method that predicts punctuations.

The present disclosure provides for a system and method for enabling voice activity detection assisted speech to text conversion.

The present disclosure provides for a system and method that predicts word category such as start word, middle word and/or end word

We claim:

1. A system enabling automatic speech recoding, said system comprising a processor that executes a set of executable instructions that are stored in a memory, upon which execution, the processor causes the system to:
receive a set of data packets from an audio device, said set of data packets corresponding an audio signal, wherein said audio signal is recorded or streamed by a speech recognition engine;
convert, by the speech recognition engine, said audio signal into textual form;
extract, by a classification engine, a first set of attributes from the textual form, said first set of attributes pertaining to any or a combination of a set of predefined class of words and punctuations for every input word converted by the speech recognition engine;
predict, by the classification engine, a second set of attributes from the first set of attributes, said second set of attributes pertaining to the set of predefined class of words and punctuations at any or a combination of beginning of the sentence, within the sentence and at the end of the sentence;
based on the predicted second set of attributes, facilitate, by an ML engine, deactivation or activation of a switching mechanism, wherein the switching mechanism controls the activation or deactivation of recording or streaming of the audio signal.

2. The system as claimed in claim 1, said audio signal pertains to a conversation between at least one user and a computing device.

3. The system as claimed in claim 1, wherein the ML engine is configured to detect, predict and discard word viruses.

4. The system as claimed in claim 1, wherein on reaching the end of sentence, the execution of the speech recognition engine is ended or deactivated by the switching mechanism, wherein the switching mechanism is configured to return the control again to the speech recognition engine comprising a voice activity detector.

5. The system as claimed in claim 1, wherein the ML engine is configured by a plurality of training data comprising a set of predefined class of words and punctuations, wherein the ML engine learns and self trains from the plurality of training data to facilitate auto activation and deactivation of the recording or streaming of the audio signal.

6. A method enabling automatic speech recoding, said method comprising:
receiving a set of data packets from an audio device, said set of data packets corresponding an audio signal, wherein said audio signal is recorded or streamed by a speech recognition engine;
converting, by the speech recognition engine, said audio signal into textual form;
extracting, by a classification engine, a first set of attributes from the textual form, said first set of attributes pertaining to any or a combination of a set of predefined class of words and punctuations for every input word converted by the speech recognition engine;
predicting, by the classification engine, a second set of attributes from the first set of attributes, said second set of attributes pertaining to the set of predefined class of words and punctuations at any or a combination of beginning of the sentence, within the sentence and at the end of the sentence;
based on the predicted second set of attributes, by an ML engine, facilitating deactivation or activation of a switching mechanism, wherein the switching mechanism controls the activation or deactivation of recording or streaming of the audio signal.

7. The method as claimed in claim 1, said audio signal pertains to a conversation between at least one user and a computing device.

8. The method as claimed in claim 1, wherein the ML engine is configured to detect, predict and discard word viruses.

9. The method as claimed in claim 1, wherein on reaching the end of sentence, the execution of the speech recognition engine is ended or deactivated by the switching mechanism, wherein the switching mechanism is configured to return the control again to the speech recognition engine comprising a voice activity detector.

10. The method as claimed in claim 1, wherein the ML engine is configured by a plurality of training data comprising a set of predefined class of words and punctuations, wherein the ML engine learns and self-trains from the plurality of training data to facilitate auto activation and deactivation of the recording or streaming of the audio signal.
